(19) United States
(12) Patent Application Publication
(10) Pub. No.: US 2003/0186065 A1
(43) Pub. Date: Oct. 2, 2003

(54) Polymeric acid protective coatings for LCD glass

(76) Inventors: Jun Hou, Painted Post, NY (US); Adrienne M. Powell-Johnson, Horseheads, NY (US); Robert G. Schaeffler, Pine City, NY (US); Youchun Shi, Horseheads, NY (US)

Correspondence Address: CORNING INCORPORATED, SP-TI-3-1, CORNING, NY, 14831

(21) Appl. No.: 10/109,463

(22) Filed: Mar. 27, 2002

(51) Int. Cl. B08B 9/00

(52) U.S. Cl. 428/441; 134/22.14

(57) ABSTRACT

Disclosed is a method for protecting surface of glass, especially LCD glass substrates, from ambient contaminants and/or contaminants produced during the processing of the glass and/or scratching. The method comprises the steps of (A) forming a protective coating on the surface of the glass by (i) applying a coating composition comprising at least one polymeric acid to the surface, and (ii) removing the solvent from the solution applied to said surface to leave a polymeric acid-containing protective coating on the surface having a thickness of at least 0.01 micron; wherein the polymeric acid-containing coating can be subsequently removed from the surface using a cleaning composition, to result in a surface which is substantially clean; and optionally (B) subsequently removing the protective coating from the surface of the glass using a cleaning composition, to result in a surface which is substantially clean.

### FIELD OF THE INVENTION

The present invention relates to protection of glass surfaces, and in particular, to the temporary protection of the surfaces of glass used in producing liquid crystal displays (LCDs). The invention is useful, for example, in protecting glass sheets from being contaminated by ambient dirt or glass chips produced during the processing of the sheets, such as cutting, grinding, packaging and transportation. In addition, the invention is useful in protecting glass sheets from scratching.

### BACKGROUND OF THE INVENTION

Many uses of glass, including glass for producing LCDs, require a very clean glass surface that is substantially free of dust and other organic and/or inorganic contaminants. When exposed to the environment, glass surface can quickly become contaminated with dust and other inorganic and/or organic ambient contaminants, with contamination being observed within a few minutes.

Current procedures used to cut and grind glass surfaces and edges often generate small glass chips. Such chips can have a size in the range between about 1 and 100 microns. Some of these particles irreversibly adhere to the clean glass surface, rendering the glass useless for many applications. This is particularly a serious problem in the case of LCD glass surfaces.

LCD glass can be made by fusion draw process, which yields flat, smooth glass surfaces that can be cut or ground to the desired size. If water is actively involved between the surface and the glass chips generated during the cutting and grinding, permanent chemical bonding may occur, rendering the adhesion of the glass chips to the surface irreversible.

One known method of protecting glass surfaces, specifically, surfaces of LCD glass sheets, is to apply a pre-formed polymer film on both major surfaces of the glass to protect the glass during the scoring, breaking and beveling process. In a typical method, one major surface has a polymer film attached with an adhesive, and the other major surface has a film attached by static charge. The first film is removed after the edge finishing (cutting and/or grinding) of the sheet is completed, while the second is removed prior to the finishing process. Although the adhesive-backed film protects the surface from scratching by the handling equipment, it causes other problems. For example, the polymer may entrap glass chips produced during the finishing process, leading to a build-up of glass chips and scratching of the glass surface, particularly near the edges of the surface. Another problem with this film is that it may leave an adhesive residue on the glass surface. A further problem with the film approach is glass breakage during peeling of the film from the glass surface, especially for large and/or thin glass sheets.

Many polymer coatings, such as polyvinyl alcohol, can offer particle protection and scratch resistance capabilities. However, few of them can be completely removed in a cleaning solution at a temperature as low as 40° C. in a typical manufacturing process. One method of temporarily protecting glass surface, especially LCD glass surface, involves applying an aqueous solution of polysaccharides (e.g., a starch) to the glass surface, forming a protective coating of the polysaccharides on the glass surface by removing water from the solution, and then subsequently removing the polysaccharide-containing coating from the surface using an aqueous solution when desired to reveal the protected surface. The removing aqueous solution may contain a detergent. The polysaccharides coating formed on the glass surface offers particle protection and scratch resistance capabilities. However, the high water solubility of polysaccharides, especially starches, constitutes a potential drawback of this method. Before the cleaning step, glass sheets are usually subject to other finishing steps such as cutting and edge grinding, in which water may be used as a cooling agent. Due to their high solubility in water, the polysaccharide coatings may be diminished during such stages, leading to reduced particles protection and scratch resistance.

A desirable property of the temporary protective coating for surface of LCD glass is its removability. Manufacturers of LCDs use the glass as the starting point for complex manufacturing processes in which semiconductors, e.g., thin film transistors, are formed on the glass substrates. In order not to adversely affect such processes, any protective coatings on the glass surface must be readily removable prior to the beginning of the LCD production process, without substantially changing the chemical and physical characteristics of the glass surface.

Therefore, there remains a need for an improved method of temporarily protecting surface of glass using a coating, especially glass for producing LCD, from being contaminated by ambient contaminants and contaminants produced during the processing of the glass and/or scratching, which is easy to remove, does not leave residue on the glass surface upon removal, whereby a substantially clean and coating-free surface can be restored for further use of the glass, e.g., for the production of LCDs.

In view of the foregoing, there has been a need in the art for a method for protecting surface of glass, especially glass sheets for the production of liquid crystal displays, which has the following characteristics:

(1) The method should be preferably one that can be easily incorporated in the overall glass forming process, specifically, at the end of the forming process, so that newly formed glass is protected substantially immediately after it is produced. Thus, the coating material should be able to withstand the environment of the glass forming line (e.g., high temperatures). In addition, the method should be safe to use in such environment;

(2) The coating must offer sufficient protection to the glass surface from being adhered to and contaminated by contaminants produced during the processing of the glass sheet, including cutting and/or grinding, and/or ambient contaminants, organic and/or inorganic, that the glass surface typically may come into contact with during packaging, storage and shipment prior to use;

(3) The coating must be sufficiently robust to continue to provide protection after being exposed to the substantial amounts of water which typically come into contact with the glass surface during the processing of the glass, including cutting and/or grinding. This requires the coating material has a sufficiently low solubility in water under the processing condition;

(4) The coating should preferably protect the glass sheet from scratching during processing, handling, shipping, and storage (as used herein, scratching includes abrasion). More preferably, the coating should permit the glass sheets to be stacked very closely with minimal spacing materials between them during handling, shipping and storage;

(5) The coating should be substantially completely removable from the glass prior to its ultimate use in, for example, producing a liquid crystal display. Preferably, the removing condition should be mild and environmentally friendly; and

(6) The coating should preserve the pristine glass surface without substantially change the surface's chemical composition and physical properties, e.g., smoothness, as a result of the coating process, the presence of coating on the surface during handling, shipping, storage and the subsequent removal of the coating from the surface.

The present invention addresses and satisfies this long-standing need in the art.

### SUMMARY OF THE INVENTION

In a first aspect, the present invention provides a method for protecting a substantially clean surface of glass from being contaminated by ambient contaminants and/or contaminants produced during the processing of the glass and/or scratching. The present inventive method comprises the steps of:

(A) forming a protective coating on the surface of the glass by (i) applying a coating composition comprising at least one polymeric acid to the surface; and (ii) removing the solvent from the solution applied to said surface to leave a polymeric acid-containing protective coating on the surface having a thickness of at least 0.01 micron;

wherein the polymeric acid-containing coating can be subsequently removed from the surface using a cleaning composition, to result in a surface which is substantially clean; and optionally

(B) subsequently removing the protective coating from the surface of glass using a cleaning composition, to result in a surface which is substantially clean.

In a second aspect of the present invention, it is provided an article of manufacture comprising:

(a) a glass sheet having at least one substantially flat surface; and

(b) a protective coating on the substantially flat surface comprising at least one polymeric acid, said coating having a thickness of at least 0.01 microns; wherein

(i) the protective coating protects the surface from ambient contaminants and contaminants produced during the processing of the glass and/or scratching; and

(ii) the protective coating can be removed through application of a cleaning composition to result in a substantially clean surface.

In certain preferred embodiments of the present invention, the coating composition is an aqueous solution comprising at least one polymeric acid.

In certain other preferred embodiments of the present invention, the cleaning composition is a basic aqueous solution having pH of equal to or above 10, and the at least one polymeric acid contained in the coating composition has a solubility in neutral water at room temperature of 0.5-50% by weight, preferably 1-40%, more preferably 2-30%, and a solubility in the cleaning composition of at least 10% by weight, more preferably at least 30%, most preferably at least 50%. More preferably, the cleaning composition is an aqueous detergent solution, e.g., a commercially available detergent package, preferably used in connection with brush washing and/or ultrasonic cleaning. Typically, the cleaning composition for removing the polymeric acid-containing protective coating is heated to a temperature in the range from 40° C. to 75° C.

In still certain other preferred embodiments of the present invention, the polymeric acid-containing protective coating is formed as a part of the manufacturing process for the glass, such as a fusion draw or a slot draw process, and the like, wherein the manufacturing process produces newly formed glass at an elevated temperature of above 150° C. when it first came into contact with the polymeric acid-containing coating composition, preferably an aqueous solution. Although it is advantageous to integrate the present inventive method into the glass manufacturing process, it can be operated off-line after the glass is manufactured if so desired. The polymeric acid-containing protective coating of the present invention has a thickness of at least 0.01 micron. Preferably, the protective coating has a thickness of less than 50 microns, more preferably between 0.1 and 20 microns.

In other preferred embodiments of the present inventive method, the coating is applied by spraying onto hot glass surface. Other coating methods can be used to carry out the step (A) of the present inventive method, including, but not limited to, dip coating, flow coating, spin coating, by equipment such as meniscus coaters, wick coaters, rollers, and the like.

In accordance with this aspect of the present invention, the method can comprise the additional steps between (A) and (B) of:

(a) cutting the glass; and

(b) grinding and/or polishing at least one edge of the glass;

wherein water or water-containing composition is applied to the coated glass surface during at least one of steps of (a) and (b).

In accordance with this aspect of the present invention, the method can also comprise the additional steps between (A) and (B) of:

(c) packing the glass with the protective coating closely with or without a spacing material; and optionally

(d) subsequently storing, shipping and/or unpacking the glass.

The method and the coated glass of the present invention result in a number of advantages over prior art. For example, the protective coating comprising at least one polymeric acid provides sufficient protection to the surface of glass against ambient contaminants and contaminants produced during the processing of the glass and/or scratching, thus potentially allows the glass sheets to be packed closely with minimal spacing material between them. In addition, the method of the present invention can be conveniently integrated into the overall glass manufacturing process, and the pristine surface of the glass can be revealed by removing the protective coating sufficiently and conveniently without substantial change to its chemical composition and physical properties.

Additional features and advantages of the invention will be set forth in the detailed description which follows, and in part will be readily apparent to those skilled in the art from the description or recognized by practicing the invention as described in the written description and claims hereof, as well as the appended drawing.

It is to be understood that the foregoing general description and the following detailed description are merely exemplary of the invention, and are intended to provide an overview or framework to understanding the nature and character of the invention as it is claimed.

The accompanying drawing is included to provide a further understanding of the invention, and is incorporated in and constitutes a part of this specification.

### BRIEF DESCRIPTION OF THE DRAWINGS

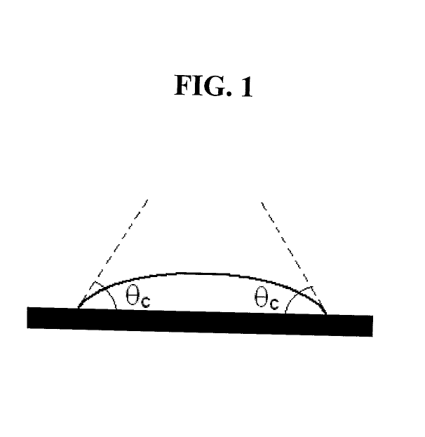

The drawing (FIG. 1) is a schematic diagram of the measurement of water contact angle on the surface of glass in the present invention.

### DETAILED DESCRIPTION OF THE PRESENT INVENTION

As used herein:

“Substantially clean” means sufficiently clean in terms of number of contaminants per unit surface area, water contact angle, surface roughness as measured by atomic force microscopy (AFM), or other parameters, such that the glass can be used for further applications as intended without the need of further cleaning of the surface.

“Polymeric acid” means a polymer capable of producing a proton upon contacting water, and/or a salt or partial salt thereof.

As embodied and broadly described herein, the present invention provides a method for temporary protection of glass surface by providing a removable coating on the surface of the glass.

Cleanliness of the surface of the glass substrate for a LCD display is of vital importance for the quality of the thin-film transistors formed on the surface of the substrate. The surface of the substrate is required to be substantially free of ambient contaminants and contaminants produced from the processing of the glass, including cutting and grinding. As discussed supra, adhesion of glass particles to the substrate surface is a long-standing problem in the manufacture of LCD glass. In particular, scoring at the bottom of draw (BOD) is a main source of adherent particles during substrate manufacturing. Ultrasonic cleaning and brush cleaning can remove some of the particles that deposited on the glass surface for a short period of time. However, such cleaning processes are not effective for particles deposited on the surface for more than a few days, especially if the storage environment is hot and humid, because permanent bonding between the particles and the glass surface may have taken place.

Therefore, it is desirable to have a protective coating that can prevent particles from adhering to the LCD glass surface at the bottom of draw. Additionally, it is also desirable for the protective coating to provide resistance to scratching, which may frequently occur during the processing, handling, storage and shipping of the substrates. Excellent scratch resistance of the coating allows the glass sheets to be packed closely to each other with minimal use of spacing material between them. Besides protecting the substrate surface from ambient dirt and glass particle contamination and scratching, the coating should preferably be removable with reasonable cleaning technique using mild cleaning procedures, for example, a cleaning procedure that includes an ultrasonic detergent wash at 40° C. combined with some brush cleaning steps. Although in principle organic solvents can be used for cleaning and removing the protective coating, they are not preferred due to health, environmental and safety concerns. Rather, a mild cleaning procedure using aqueous cleaning composition is preferred.

Many commercial polymer products can be applied to the glass surface to form protective coatings, but they are not necessarily sufficiently removable from the glass surface under the above cleaning conditions due to their strong interactions with the glass surface. For example, there are many organic coatings having good water solubility at higher temperatures. However, the cleaning temperature of 40° C. is too low for many of them to be sufficiently removed from the glass surface. Moreover, although good aqueous solubility is desired, a coating should not be highly hygroscopic because it must be able to withstand a hot and humid environment without decreasing its coating effectiveness. In addition, in order not to change the surface chemistry and major physical characteristics, inter alia, smoothness, so that the glass surface revealed upon removal of the protective coating is fit for producing liquid crystal display without further surface treatment, the coating composition, the protective coating per se and the cleaning composition should not be chemically active or detrimental toward the glass surface.

### A. Polymeric Acid Protective Coating and Coating Composition Comprising Polymeric Acid

In accordance with the present invention, the protective coating formed on the glass, and the coating composition used to form the protective coating, comprise at least one polymeric acid. More particularly, the protective coating of the present invention consists essentially of at least one polymeric acid. As used herein, the term “consist essentially of” means that the coating or the coating composition can contain ingredients other than polymeric acid, provided those ingredients do not materially affect the novel and basic features of the coating. Thus, “a coating consisting essentially of at least one polymeric acid” contains at least one polymeric acid and may comprise other ingredients, such as binders, solvents, biocides, plasticizers, and the like, as long as the other components do not materially affect the novel and basic feature of the protective coating of the present invention. In the practice of the present invention, a single or a mixture of more than one polymeric acid can be used in the coating composition and the protective coating. For example, a single coating can comprise a single polymeric acid, or a mixture of two, three or more polymeric acids. Alternatively, a plurality of coatings comprising different polymeric acids may be sequentially applied.

The polymeric acid-containing protective coating of the present invention can be formed directly on a substantially clean glass surface. Alternatively, to achieve optimal surface protection, the present inventive polymeric acid-containing protective coating can be formed on a non-polymeric acid-containing protective coating that is applied to the glass surface in advance. Also, additional protective coating that does not contain polymeric acid can be applied on top of the polymeric acid-containing protective coating of the present invention. Such protective coatings that do not contain polymeric acid include, but are not limited to, polysaccharide coatings, such as coating formed from starch and starch derivatives, polyvinyl alcohol, and a hydrocarbon gel such as a petrolatum. A fabric or polymer film may be attached over the coating by static charge, adhesive or other means to provide further protection to the glass surface.

Polyelectrolytes are polymers with ionizable groups on their chain, and therefore, tend to ionize in aqueous solutions. The degree of ionization of polyelectrolytes varies depending on the number and properties of the ionizable groups on the polymer chains, polymer chain structure and pH of the solution. The at least one polymeric acid in the protective coating and the coating composition of the present invention is a group of polyelectrolytes having on their chains at least one group capable of producing a proton upon contacting water, such as a —COOH group (carboxylic acid), a hydroxyl group in phenol and its derivatives, an anhydride group, and the like. The polymeric acid used in the present invention can be an acidic homopolymer, a copolymer, including random, alternate and block copolymer, or a combination thereof. The number of ions on the polymeric acid chain varies as a function of the pH of the aqueous solution. Without intending to be bound by any particular theory, applicants believe that at higher pH, the acidic groups tend to dissociate better to form more ions and thus more electrical charges on the chain, leading to a high solubility of the polymeric acid in the aqueous solution, and vice versa. Thus, the polymeric acid coating of the present invention can provide resistance to neutral water used as cooling agent in the cutting and/or grinding steps because of its relatively low solubility at neutral pH, and accordingly offer robust protection to the glass surface from contaminants during such processing steps of the glass, inter alia, glass chips. In the meantime, the polymeric acid protective coating of the present invention can be readily removed in a typical aqueous cleaning composition, which normally has pH higher than 10, where the polymeric acid has a higher solubility. It is this variable and controllable solubility of the polymeric acid coating that provides the coating a combination of robust protection during cutting and grinding when water is used, and sufficient removability in a cleaning composition, which preferably has higher pH.

A wide variety of polymeric acids are known. General discussion of polymeric acid and chemistry of polymeric acid can be found in the following reference, the relevant portion of which are incorporated herein by reference: Berkturov E. A., Bimendina L. A. & Kudaibergenov S. E., Polyelectrolytes, Polymeric Materials Encyclopedia, Volume 8 (Salamone J. C Editor-in-Chief, CRC Press, 1996) 5800; Polyelectrolytes and Their Applications (Rembaum, A. & Selegny, E. Eds., Reidel: Dordrecht, Germany, 1975); Finch, C. A., Chemistry and Technology of Water-soluble Polymers (Plenum: New York, N.Y. 1983); and Glavis F. J., Poly(acrylic acid) and Its Homologs in Water-Soluble Resins (Davidson R. L. & Sittig M. Eds., Chapman & Hall, Ltd., London 1962) 133. Non-limiting examples of polymeric acid suitable for the coating composition and the protective coating of the present invention are homopolymers, copolymers, mixtures and other combinations of acrylic acid, methacrylic acid, maleic acid and their anhydrides, and polymers containing an acidic hydroxyl group as in the case of phenol and their derivatives. Many polymeric acid suitable for use in the present invention are commercially available, for example, polyacrylic acid and poly(methyl vinyl ether-alt-maleic acid) from Aldrich. However, where aqueous coating composition is used, polymeric acid insoluble in water cannot be used. Under this circumstance, isostatic polyacrylic acid cannot be used because it is largely insoluble in water due to the formation of intra-molecular hydrogen bonds between the —COOH groups.

As defined supra, polymeric acid as used herein includes polymers having at least one group capable of producing a proton upon contacting water, and/or a salt or partial salt thereof. A partial salt is a polymeric acid with a part of the acidic groups on its chain neutralized by a base. For example, a partial ammonium salt of a polymeric acid is a polymeric acid partially neutralized by ammonia. As long as the polymeric acid-containing protective coating formed on the glass demonstrates sufficiently low solubility in water and sufficiently high solubility in the cleaning composition under an acceptable condition, the polymeric acid used in the coating composition and the formed coating of the present invention can be neutralized by one or more base in any suitable proportion. Thus, the polymeric acid in the coating composition and the formed coating may take various forms in various proportions. The salt and/or partial salt can be an ammonium salt, a sodium salt, a potassium salt, and the like, or a combination thereof. Preferably, the salt and/or partial salt, if contained in the polymeric acid, is ammonium salt or an alkaline metal salt. More preferably, the salt and/or partial salt is an ammonium salt. Where the present invention coating composition is applied directly to a glass surface without a base coating, alkaline metal salts should generally be avoided and ammonium salt is preferred. The proportion of salt can range from 0% to 100%.

The polymeric acid used in the coating composition and the protective coating of the present invention has a solubility in neutral water at room temperature of 0.5-50% by weight, preferably 1-40%, more preferably 2-30%. Where an organic solvent is used in the coating composition to facilitate dissolution of the polymeric acid in the coating, solubility of the polymeric acid in water can be very low. On the other hand, if an aqueous coating composition is used, it is desired that the polymeric acid has an acceptable solubility in water to form a coating composition with sufficient concentration. In any event, to offer sufficient protection during water treatment in the glass processing, the polymeric acid used in the coating should not have too high a solubility in water. For sufficient removability of the protective coating from the surface of the glass in order to release a pristine surface without residue thereof, it is desired that the polymeric acid used in the present invention has a solubility of at least 10% by weight in the cleaning composition at the cleaning temperature and pH, preferably at least 30%, and more preferably, at least 50%.

To offer sufficient protection to the glass surface, the polymeric acid-containing coating of the present invention should desirably have a thickness of at least 0.01 micron. In order for the protective coating to be conveniently removable in the cleaning composition, it is desired that its thickness be less than 50 microns. Preferably, the coating is between 0.1 and 20 microns in thickness, to achieve a good balance of protection and ease of removal.

The coating composition is preferably an aqueous solution of the polymeric acid due to concerns of health, environment, safety and economy. However, organic solvents may be used alone or in addition to water to dissolve the polymeric acid to form the coating composition. Nonlimiting examples of organic solvents include alcohols, ketones, terahydrofuran and ethers. Concentration of polymeric acid in the coating composition is not crucial to the present invention. For coating compositions with a higher concentration, coating can be effected with fewer application cycles and less application time. For coating compositions with a lower concentration, the protective coating of sufficient thickness can be obtained by multiple application cycles. Spray coating of aqueous coating composition is a preferred method of the present invention for applying the protective coating to glass surface. For such applications, it is desired that the concentration of the polymeric acid in the coating composition be between 0.1-30% by weight. Viscosity of the coating composition varies as a function of the concentration of the polymeric acid in the coating composition. For applications of spraying coating of aqueous solution, the viscosity of the coating composition is preferably between 0.1 and 100 centipoise.

The coating composition can be prepared by dissolving the polymeric acid in deionized water and/or other solvents. Optional components can be added to the coating composition, thus to the protective coating, to adjust the coating properties, solubility or dispersion of polymeric acid in the solution, or to inhibit growth of biological materials in the protective coating and coating composition, and the like, in suitable amounts such that they will not materially affect the novel and basic features of the present inventive coating. Concentrated coating compositions can be prepared, stored, and diluted to the application concentration when desired.

Some of the polymeric acid coating compositions of the present invention may be bio-degradable, which means they may be attacked by microorganisms such as bacteria and fungi. Under such circumstances, the coating composition and the protective coating of the present invention preferably contain a biocide to inhibit growth and attack of biological materials during the storage and shipment of the coating composition and coated glass. To this end, some commercial biocides, for example, KATHLON LX (Rohm & Haas) can be used. Sorbic acid and p-hydroxybenzoic acid esters are additional examples. Inclusion of boric acid in the coating composition can also inhibit growth and attack of certain microorganisms. A biocide may change the chemical and mechanical properties of the coating. The amount of biocide in the coating composition, which thus becomes a part of the protective coating, should not exceed 20% by weight of the polymeric acid. Typically, concentration of a biocide in the coating composition is in the range of 50 ppm and 0.1% by weight.

The coating composition and the protective coating of the present invention may also contain one or more plasticizers which may be a polyhydroxy compound. Examples of suitable plasticizers include, but are not limited to, sorbitol, glycerol, ethylene glycol, polyethylene glycol, and mixtures thereof. Such components can reduce the probability of the coating to become overly brittle at low humidity. Such plasticizers can also enhance the physical properties of the protective coating in terms of smoothness, mechanical strength which determines its scratch resistance, as well the longevity of the coating. Typically, concentration of plasticizers in the coating composition can range from 0 to 30% by weight of the polymeric acid.

The above description of biocides and plasticizers as optional components are not exhaustive, but are illustrative only. Other components can be added to the coating composition and become a part of the protective coating on the glass surface if desired, as long as they do not affect the novel and basic features of the present inventive protective coating.

The protective coating of the present invention, either used alone or in conjunction with protective coatings of other nature, offers excellent protection to the glass surface from ambient contaminants and contaminants produced during the processing of the glass, can withstand water treatment during the process of the glass, and can be removed sufficiently to reveal a substantially clean glass surface for further applications. In addition, the coating composition and the protective coating do not have a corrosive nature to the glass surface. They will not substantially alter the surface chemistry and physical properties, inter alia, smoothness, of the glass, such that upon removal of the coating, a substantially clean and pristine surface is revealed for down-stream uses.

### B. Forming the Protective Coaintg on the Glass Surface

As discussed above, to achieve the optimal protection to the glass surface, the polymeric acid-containing coating of the present invention can be applied directly to a substantially clean glass surface, or on the top of a coating that has already been applied on the glass surface. Further coating that does not contain polymeric acid can be used on the top of the polymeric acid-containing as well if desired. Such coatings below or over the polymeric acid-containing protective coating of the present invention can be, inter alia, a polysaccharide coating, such as a coating formed by starch or starch derivatives, or a surfactant coating (below or over), a polyvinyl alcohol coating (over), and hydrocarbon gel (over) such as petrolatum. A fabric or a polymer sheet can be attached on the top of the coatings by static charge or other means for additional protection, especially during handling and shipping.

Various application approaches can be used to apply the coating composition of the present invention to form the protective coating. Upon removal of the solvent from the coated composition, a layer of the polymeric acid protective coating will be formed. Spray coating, dip coating, brush coating, spin coating are non-limiting examples of coating methods that can be used. Various coating equipment, such as meniscus coaters, wicker coaters, rollers, brushes, and the like, can be used. However, the preferred coating method for the application of the coating composition of the present invention is by spraying coating because this method readily accommodates movement of the glass imparted by the glass manufacturing process. In one embodiment of the coating method of the present invention, the coating composition is applied to a glass surface having a temperature in the range of 20-250° C. using an air spray gun with a pressure in the range of 20 to 60 psi. Where the glass surface has a high temperature, such as that of a newly formed glass, solvents contained in the coating composition can evaporate without further heating. In addition to normal air spray nozzles, other types of spray nozzles such as airless nozzles, air-assisted nozzles, high volume low pressure air nozzles, electrostatic air nozzles and electrostatic rotary nozzles may also be used. For glass surfaces having a relatively low temperature, such as ambient temperature, it may be desired to use drying equipment to facilitate evaporation of solvent. A non-limiting example of such drying equipment is an infrared lamp optionally coupled with ventilation, or air drying. Where the glass has more than one major surfaces, the coating composition may be applied to one surface only, or to all the major surfaces, simultaneously or sequentially. For example, for a LCD glass sheet, the coating composition is usually applied to its both major surfaces, which are substantially flat.

The present inventive coating method can be advantageously integrated into the glass manufacturing process, such as slot draw process, fusion draw process, float process, and the like. See, for example, U.S. Pat. Nos. 3,338,696 and 3,682,609, which are incorporated herein by reference in their entirety. The coating composition can be applied directly to the hot glass surface immediately after it is formed. In one embodiment of the method of the present invention, shortly after a glass sheet is formed, the coating composition, especially aqueous coating composition, is applied to the surface of a glass sheet having a temperature of at least 100° C., preferably over 150° C., more preferably over 180° C. The temperature of the glass can be measured, for example, conveniently using infrared detector of the type commonly used in the glass making art. However, because the polymeric acid and other optional components in the coating composition may decompose or be subjected to oxidation and/or other chemical changes at too high a temperature, it is preferred that the glass surface has a temperature lower than about 250° C. when the coating composition is applied. Where aqueous coating composition is used, the glass temperature can be as high as 300° C. without significant decomposition of the polymers and other components because water contained in the coating composition has a high evaporation heat, the evaporation of which will promptly cool the glass down to a non-damaging temperature. Where the glasses are formed by slot-draw or fusion-draw process, the newly formed glass sheet is oriented in a vertical direction. Under these circumstances, the coating composition should be applied under conditions that do not result in the formation of drips as such drips can interfere with the subsequently scoring of the glass, e.g., those drips may cause the glass to crack during cutting. Generally speaking, dripping can be avoided by selecting the proper temperature at which spraying starts and adjusting the spray throughput to keep the glass sheets at a relatively high temperature, e.g., 100° C. when aqueous coating composition is used, or by adjusting spray conditions such as liquid droplet size, distance between the spray nozzles and the glass surface, air flow rate, coating solution liquid flow rate, etc. At too low a temperature, the coating dries too slowly and forms drips on the surface. The concentration of the coating composition, spray throughput and spray-starting temperature can be chosen such that while no drip forms on the surface, the thickness of protective coating is still sufficient to provide adequate protection to the surface in subsequent processing and handling steps of the glass.

Integration of the protecting method of the present invention into the glass manufacturing process has several advantages. First, coating the clean surface of newly formed glass at an early stage protects the glass surface at the remainder of the glass processing process. Second, the residual heat of the newly formed glass can be taken advantage of reducing the coating time and energy consumption in connection with the coating process. Of course, the application time and rate should be determined in light of factors such as the glass forming rate, the desired minimum glass temperature at the end of the application process, and the like.

The temperature of the coating composition is preferably in the range of 20° C. to 85° C., i.e., heated coating composition can be used. Heating the coating composition before application has several advantages. One benefit involves reduction of drying time of the protective coating. Secondly, increased solubility of polymeric acid in the solvent and reduced viscosity of coating composition at a higher temperature allow a higher coating rate. Thirdly, where spraying coating is employed, lower viscosity at higher temperature is beneficial in achieving atomization of the solution, thus facilitating the construction of a smooth and uniform coating.

After the protective coating is formed on the glass surface, and before the protective coating is removed by using a cleaning composition to reveal a substantially clean surface for the production of an end product, for example, a liquid crystal display, the glass may be subject to further treatment, for example, cutting and grinding, storage, handling and shipping. Generally, water is used in the cutting or grinding processes as cooling agent. Also during cutting and grinding of the glass, contaminants such as glass chips are formed, which tend to contaminate the glass surface if no sufficient protection is provided, as discussed above. The polymeric acid-containing protective coating of the present invention has a low solubility in water, therefore its protective effect against contaminants produced during the glass processing or encountered in subsequent handling, packing, storage, unpacking, and the like, will not be significantly diminished as a result of its contact with water. Advantageously, to offer better protection, the coating is dried after water treatment where necessary. Also, the polymeric acid-containing protective coating of the present invention withstands harsh environment that the coating may come into contact with, such as high humidity and high temperature. Advantageously, the coating of the present invention also provides good scratch resistance, making glasses thus coated possible to be packed closely with one another with minimal and even no spacing materials between them. This can potentially reduce shipping cost of the glasses, especially when long-distance and/or transcontinental transportation is involved.

### C. The Cleaning Composition and Removal of the Protective Coating

It is desired for a successful protective coating to withstand the manufacturing process and still be sufficiently removable when necessary. The polymeric acid-containing coating of the present invention can be applied to the surface of glass before it is scored for the first time and are strong enough to survive the rest of the manufacturing process. The protective coating of the present invention can be readily removed by a cleaning composition, either alone or in combination with application of additional cleaning technique, such as mechanical brushing, ultrasonic wave energy, and the like. Other alternative techniques for the removal of the coating, such as oxidization, e.g., ozone-based oxidation, CO₂ cleaning, CO₂ snow cleaning, O₂ plasma and pyrolysis cleaning can be employed either alone or in combination with other removing techniques, although the use of a cleaning composition is preferred.

The cleaning composition for use in the present invention should advantageously be of a mild nature, which provides sufficient removability of the protective coating without substantially altering the chemical composition and physical properties, inter alia, smoothness, of the glass surface. The application of brushing and energy should meet this requirement as well. Though cleaning compositions based on or comprising organic solvents such as alcohols, tetrahydrofuran, ketones and ethers can be used for removing the protective coating in the present invention, an aqueous cleaning composition is preferred for environmental, health and safety concerns. The polymeric acid used in the present invention should have a solubility of at least 20% by weight, preferably at least 30%, more preferably at least 40%, in the cleaning composition at the cleaning temperature. Therefore, when an aqueous cleaning composition is employed, it is generally in alkaline pH, usually at least 10, preferably at least 11, more preferably around 12.5. However, very strongly basic solution should be avoided because they may react with the glass surface and change the chemical composition and/or physical parameters thereof. Any reactive component that will change the chemical and physical natures of the glass surface should be avoided. Typically, a mild detergent with various compositions is a part of the cleaning solution, which facilitates removal of the protective coating and other oily materials and particles. Where a detergent is present, its concentration in the cleaning composition is in the range of 2-8% by weight, and the cleaning composition will have alkaline pH. Removal of the protective coating can be conducted at a temperature in the range of 20-75° C., with higher temperatures normally resulting in more efficient removal of the coating, particles and organic contaminants. Cleaning time is normally between 1 and 20 minutes.

It should be noted that the removal of the coating can be done by the manufacturer of the glass or by the end user of the glass, such as a manufacturer of liquid crystal devices, after the glass is shipped with the protective coating thereon to the end user.

To verify removal of a coating, the wettability of the glass surface before and after the removal of the glass can be measured and compared. Water contact angle is a good indicator of wettability, which can be obtained using a variety of known methods in the art. A schematic diagram of the contact angle measurement is shown in FIG. 1, wherein θ_{c} is the contact angle, also referred to as the sessile drop contact angle in the art. Advantageously, the water contact angle of the glass surface upon removal of the protective coating has a value of less than or equal to 8°, indicating the glass surface is substantially clean. Other methods that can be used to determine coating removal include XPS (X-ray photoelectron spectroscopy) and TOF-SIMS (Tim-of-flight-secondary ion mass spectroscopy), which can be used in combination with water contact angle measurement.

The following examples provide further illustration of the present invention, and are not intended to limit the scope of the present invention to the specific embodiments described therein.

### D. EXAMPLES

In the following examples, glass sheets used for the testing were 1737 LCD glass samples (5″×5″×0.7″ mm) produced by Corning Incorporated, Corning, N.Y. Each sheet was covered on one side with a polymer film attached with an adhesive, and the other major surface had a film attached by static charge. Both coatings were removed from glass sheets followed by pre-cleaning All glass sheets were pre-cleaned before application of the coating compositions.

Water contact angles were measured to evaluate cleanness and removability of coatings in the examples. It has the advantages of being quick and easy. The polymeric acid-containing coatings of the present invention are organic polymers and have lower surface energies than glass surface, thus higher water contact angle are observed when these coatings are present on the glass surface. For a substantially clean glass surface absent of polymer residues and contaminants, the water contact angle should be extremely low due to the high surface energy of the clean glass surface.

Three different control samples were used to identify sources of contamination and as benchmarks for coated samples as follows:

Control A: uncoated and uncontaminated. This control was kept in a pre-cleaned individual photomask handling case. The case was opened in the clean-room.

Control B: uncoated but contaminated with glass particles. This control was used to determine the effectiveness of the coating in providing particle protection.

Control C: uncoated and uncontaminated. The difference between this control and Control A is that this control was exposed to the exact same environment as the coated/contaminated substrates. This control could thus detect contamination sources other than the scraped glass particles.

### Example 1

This example was designed to test the removability of polymeric acid-containing coating from glass surface.

Polyacrylic acid (ACROS catalog number 18501) and poly(methyl vinyl ether-alt-maleic acid) (Aldrich catalog number 19112-4) were dissolved in deionized water to form solutions thereof. Ammonium hydroxide was added to the solutions to adjust pH to about 5. Final concentration of polyacrylic acid and poly(methyl vinyl ether-alt-maleic acid) in the solutions were 2.5% and 2.0% by weight, respectively.

Precleaninng of glass sheets and removal of coating from them in this example were carried out in accordance with the following procedures: (1) 2% SEMICLEAN KG was sprayed on the substrates or coatings and hand-scrubbing performed using a clean-room cloth; (2) the substrates or coatings were subjected to ultrasound cleaning (40 kHz, 2% SEMICLEAN KG, about 40° C.) for 15 minutes; and (3) the substrates or coatings were subjected to brush cleaning with 2% SEMICLEAN KG and deionized water, and spin-drying using a brush cleaner (ULTRATECH 605 Photomask/Substrate Cleaner).

Each of the two coating compositions was applied by spraying onto the tested surface of a pre-cleaned glass sheet, which was pre-heated to 200° C. Glass sheets were allowed to cool naturally to room temperature and air-dried to form a polymeric acid-containing coating on the glass surface. Water contact angle on the surfaces of the three glass sheets resulted were measured and reported in TABLE 1 as first contact angle.

Each of glass sheets coated with a polymeric acid was then subjected to a coating removal procedure as described above. Water contact angle was measured again on the thus cleaned and dried glass surfaces and reported in TABLE 1 as second contact angle.

TABLE 1

| | First Contact | Second Contact |
|---|---|---|
| Coating Composition | Angle (°) | Angle (°) |
| Polyacrylic acid (2.5 wt %) | 28 | ≦8 |
| Poly(methyl vinyl ether-alt-maleic | 50 | ≦8 |
| acid)(2.0 wt %) | | |

Changes between first contact angle and second contact angle in TABLE 1 show that the glass surfaces after the removal of the protective coating were substantially clean, i.e., the coatings were sufficiently removed to reveal a substantially clean glass surface. Thus, excellent removability of the polymeric acid-containing protective coatings in this mild aqueous cleaning composition was demonstrated in this example.

### Example 2

In outline, experimental procedure used in this example include the following steps: (1) pre-clean glass substrates and measure initial particle count; (2) dip-coat substrates and air-dry the coating; (3) heat substrates for 2 minutes at 200° C.; (4) contaminate substrates with glass particles by scraping edges of two pieces of LCD glass on uncoated control and coated substrates; (5) age the particle-contaminated substrates and all controls in a humidity chamber with 85° C./85% relative humidity for 7 days; (6) clean the substrates, including the coated substrates and controls; (7) count particles on cleaned substrates, including the coated substrates and controls; (8) examine the surface composition of pre-cleaned uncoated and uncontaminated glass substrate controls and cleaned coated glass substrates using X-ray photoelectron spectroscopy (XPS); and (9) examine surface smoothness of pre-cleaned uncoated and uncontaminated glass substrate controls and cleaned coated glass substrates using atomic force microscopy.

The change in particle count on a substrate was obtained by comparing the particle count before and after the process. Particle protection effectiveness of a coating was estimated by comparing particle density on coated and uncoated substrates.

Particle contamination and aging were performed in a normal chemical laboratory. Cleaning, coating and particle inspection were done in a clean-room. The purpose of doing the coating in a clean-room was to keep the glass substrates away from unknown contamination sources. Spray-coating has a great potential to contaminate a clean-room and thus dip-coating was performed in the clean-room for these experiments.

Pre-cleaning of glass sheets, removal of adhesive residue and removal of protective coating from them were carried out using the following steps: (1) rinsing the substrates with room-temperature deionized water, after which the substrates were placed in deionized water to prevent drying out; (2) hand-scrubbing with 2% SEMICLEAN KG at 40° C.; (3) ultrasonication (72 kHz) in 2% SEMICLEAN KG at 40° C. for 15 minutes; (4) flood-rinsing with deionized water; (5) ultrasonication (40 kHz) in deionized water at 40° C. for 3 minutes; (6) ultrasonication (72 kHz) in deionized water at 40° C. for 5 minutes; (7) flood-rinsing with deionized water; and air drying. A variety of ultrasonic frequencies were used in order to provide cleaning for a greater range of particle sizes.

The initial number of particles on the surface of pre-cleaned substrates was counted after they had been dried in air.

The cleaned substrates were immersed in a coating composition (<5 seconds) piece by piece, and taken out for air drying over night. Dried substrates were heated at 200° C. for 2 minutes to simulate the spray-coating temperature. Except for some controls kept in pre-cleaned photomask handling cases individually, all particle-contaminated samples on a first open PYREX rack and all uncontaminated samples on a second open PYREX rack were placed in an oven set to 100° C. for 5 minutes. This pre-heating was performed to avoid water condensation on cold substrates in the high temperature/high humidity chamber which could wash away some of the coating. The substrates were immediately transferred to polypropylene racks and placed in a humidity chamber with 85% humidity at 85° C. The substrates were taken out of the humidity chamber after 7 days for cleaning.

Particle numbers were counted using Argus optical particle counter that is equipped with a CCD camera to detect light scattering. The equipment provided information regarding particles of all sizes and particles larger than or equal to 10 microns.

Pre-cleaned glass sheets were examined using the Argus particle counter, to measure the residue particle density on the surface of glass sheets. A 5% by weight aqueous solution of Darvan 821A, which is a polyacrylic acid ammonium salt, was prepared and used as coating composition. Three pieces of glass sheets were dip-coated using this coating composition. Coated glass sheets were placed into an oven at 200° C. for 2 minutes. Then, the oven thermostat was turned down to 100° C. and the coated glass sheets were kept at that temperature for 2 minutes. Samples were then removed from the oven and allowed to cool. Coated substrates were contaminated with glass particles by scaping edges of two pieces of 1737F glass. The contaminated substrates were stored in a humidity chamber at 85° C./85% relative humidity. Aged for 7 days in the humidity chamber, substrates were cleaned using the procedures for pre-cleaning and coating removal as described above. The Argus was used to measure the particle density on the cleaned glass sheets again. TABLE 2 shows the increase of particle density after the coating removal and before the coating. Particle density is defined as the number of particles per square centimeter. Increase of particle density is calculated by subtracting particle density of sample surface after processing from that of surface before processing. Control samples were Control B.

TABLE 2

| | Increase of | | |
|---|---|---|---|
| | Macro- | Increase of Particle | Increase of Particle |
| | contamina- | Density of All | Density of Particles |
| | tion area | Particles | >10 μm |
| Surface of | 15% | 13.8 ± 1.0 | 3.14 ± 0.37 |
| Control B | | | |
| Coated Surface | None | 0.40 ± 0.4 | −0.04 ± 0.13 |

In TABLE 2, macro-contamination area is the percentage area heavily contaminated by particles and uncountable by the particle counter, i.e., the area with a particle density exceeding 25 particles/cm². The increase of particle density was calculated based on the final and initial particle densities in the area without macro-contamination. Control and coated samples were prepared and examined in triplicate. The numbers before the plus/minus sign (±) represent the average of testing results of three tested samples, and after the plus/minus sign (±), the standard deviation of the testing result of the three samples. A negative number of the particle density increase means that the particle density actually reduced after cleaning and/or removal of the protective coating. Uncoated control samples, having an average of 15% micro-contamination area, were heavily contaminated but no macro-contamination was observed on the surface of glass sheets coated with the polymeric acid-containing coating of the present invention. With macro-contamination being excluded, polyacrylic acid coated glass sheets were still more than 10 times cleaner at both >0 μm and >10 μm particle contamination levels.

Surface of coated glass sheets thus cleaned and surface of Control A, which was a pre-cleaned glass without being contaminated or other further treatment, were then examined using XPS and AFM, with results reported in TABLE 3 and TABLE 4, respectively. The data in TABLE 4 were obtained by measuring 20×20 μm area. Ra stands for average roughness and Rms for mean square roughness.

TABLE 3

| Sample | C | Al | Si | O |
|---|---|---|---|---|
| Surface of Control A | 7.2 | 5.2 | 22.5 | 59.0 |
| Coated Surface | 7.8 | 5.3 | 23.4 | 58.1 |

TABLE 4

| | Rms (nm) | Ra (nm) |
|---|---|---|
| Surface of Control A | 0.32 | 0.25 |
| Coated Surface | 0.33 | 0.26 |

Data in TABLE 3 shows that the chemical composition of the glass surface was not substantially changed as a result of application of coating composition, contamination, aging, coating removal and cleaning procedures. The comparable C data of the control and the coated surface indicate that the coating was substantially completely removed. The roughness data in TABLE 4 shows that the surface revealed after removal of the protective coating of the present invention was close to that of a control. It is clear that the pristine surface of the LCD glass sheets was not affected by the glass particles produced during the contamination procedure, and that it was protected and preserved by the protective coating of the present invention, and restored to substantially clean upon removal of the coating. The coating composition, application of coating, contamination and aging with a coating on the surface, removal of the coating and cleaning procedures did not substantially change the chemical composition and physical properties of the LCD glass surface.

It will be apparent to those skilled in the art that various modifications and alterations can be made to the present invention without departing from the scope and spirit of the inventing. Thus, it is intended that the present invention cover the modifications and variations of this invention provided they come within the scope of the appended claims and their equivalents.

What is claimed is:

1. A method for protecting a substantially clean surface of glass from ambient contaminants and/or contaminants produced during the processing of the glass and/or scratching, said method comprising the steps of:
(A) forming a protective coating on the surface of the glass by (i) applying a coating composition comprising at least one polymeric acid to the surface, and (ii) removing the solvent from the solution applied to said surface to leave a polymeric acid-containing protective coating on the surface having a thickness of at least 0.01 micron;
wherein the polymeric acid-containing coating can be subsequently removed from the surface using a cleaning composition, to result in a surface which is substantially clean; and optionally
(B) subsequently removing the protective coating from the surface of the glass using a cleaning composition, to result in a surface which is substantially clean.

2. A method in accordance with claim 1, wherein the surface of glass is substantially flat.

3. A method in accordance with claim 2, wherein the glass is a glass sheet having two substantially flat surfaces and steps (A) and optionally (B) are applied to at least one of the two surfaces.

4. A method in accordance with claim 3, wherein the glass is used to make liquid crystal displays after step (B).

5. A method in accordance with claim 1, wherein the glass surface after step (B) has a water contact angle of less than or equal to 8°.

6. A method in accordance with claim 5, wherein after step (B), the glass surface has a Rms surface roughness as measured by atomic force microscopy of less than or equal to 0.40 nanometers.

7. A method in accordance with claim 5, wherein the coating composition is an aqueous solution comprising at least one polymeric acid.

8. A method in accordance with claim 7, wherein the total concentration of the at least one polymeric acid in the coating composition is between 0.1% and 30% by weight.

9. A method in accordance with claim 8, wherein the viscosity of the coating composition is between 0.1 centipoise and 100 centipoise.

10. A method in accordance with claim 7, wherein the polymeric acid contains at least one salt or partial salt thereof.

11. A method in accordance with claim 10, wherein the at least one salt or partial salt is selected from ammonium salt and alkaline metal salts.

12. A method in accordance with claim 11, wherein the at least one salt or partial salt is ammonium salt.

13. A method in accordance with claim 7, wherein the cleaning composition is a basic aqueous solution having pH of equal to or above 10, and the at least one polymeric acid has a solubility in neutral water of between 0.5-50% by weight, and a solubility in the cleaning composition of at least 10% by weight.

14. A method in accordance with claim 13, wherein the at least one polymeric acid has a solubility in the cleaning composition of at least 30%.

15. A method in accordance with claim 13, wherein the at least one polymeric acid has a solubility in the cleaning composition of at least 50%.

16. A method in accordance with claim 13, wherein the total concentration of the at least one polymeric acid in the coating composition is 2-30% by weight.

17. A method in accordance with claim 13, wherein the cleaning composition comprises a detergent.

18. A method in accordance with claim 7, wherein the at least one polymeric acid is selected from the group consisting of (i) homopolymers and copolymers of carboxylic acid, phenols and acid anhydrides, salts and partial salts thereof, and (ii) mixtures and other combinations of the polymers.

19. A method in accordance with claim 18, wherein the at least one polymeric acid is selected from the group consisting of (i) homopolymers and copolymers of acrylic acid, methacrylic acid, maleic acid and their hydrides, salts and partial salts thereof, and (ii) mixtures and other combinations of the polymers.

20. A method in accordance with claim 18, wherein the cleaning composition is a basic aqueous solution having pH of equal to or above 10, and the at least one polymeric acid has a solubility in neutral water of 0.5-50% by weight, and a solubility in the cleaning composition of at least 10% by weight.

21. A method in accordance with claim 20, wherein the at least one polymeric acid has a solubility in neutral water of 1-40% by weight, and a solubility in the cleaning composition of at least 30% by weight.

22. A method in accordance with claim 20, wherein the at least one polymeric acid has a solubility in neutral water of 2-30% by weight, and a solubility in the cleaning composition of at least 50% by weight.

23. A method in accordance with claim 13, wherein step (A) is performed as part of the manufacturing process of the glass.

24. A method in accordance with claim 13, wherein step (A) is performed by applying the aqueous coating composition to the surface of the glass at ambient temperature, and subsequently removing the solvent from the coating using a drying equipment.

25. A method in accordance with claim 23, wherein the manufacturing process produces newly formed glass at an elevated temperature and step (A) is performed by applying the aqueous coating composition to the newly formed glass at a point in the manufacturing process where the temperature of the newly formed glass just prior to contact with the aqueous solution is above 150° C.

26. A method in accordance with claim 25, wherein the temperature of the newly formed glass just prior to contact with the aqueous solution is below 300° C.

27. A method in accordance with claim 25, wherein the temperature of the newly formed glass just prior to contact with the aqueous solution is below 250° C.

28. A method in accordance with any one of claims 25 to 27, wherein the glass is manufactured by fusion draw or slot draw process.

29. A method in accordance with claim 25, wherein the glass is vertical in step (A) and the temperature of the glass remains sufficiently high throughout step (A) so that drips do not form on the surface.

30. A method in accordance with claim 25, wherein the temperature of the glass is at least 100° C. at the end of step (A).

31. A method in accordance with claim 1 or 13, wherein the coating composition is applied to the glass surface by spraying.

32. A method in accordance with claim 1 or 13, wherein the coating composition is applied to the glass surface by dipping the glass into the coating composition.

33. A method in accordance with claim 1 or 13, wherein the coating composition is heated before application thereof to the glass surface.

34. A method in accordance with claim 1 or 13, further comprising the additional steps between steps (A) and (B) of:
(a) cutting the glass; and
(b) grinding and/or polishing at least one edge of the glass;
wherein water or water-containing composition is applied to the coated glass surface during at least one of steps of (a) and (b).

35. A method in accordance with claim 1 or 13, further comprising the additional steps between steps (A) and (B) of:
(c) packing the glass with the protective coating closely to another piece of glass with or without a spacing material; and optionally
(d) subsequently storing, shipping and unpacking the glass.

36. A method in accordance with claim 1 or 13, wherein the polymeric acid-containing protective coating has a thickness of less than 50 microns.

37. A method in accordance with claim 1 or 13, wherein step (B) comprises one or more steps selected from: heating the aqueous cleaning composition to a temperature in the range from 40° C. to 75° C.; applying ultrasonic energy to the glass surface, the protective coating and the cleaning composition; and brush washing the glass surface with the protective coating.

38. A method in accordance with claim 1 or 13, wherein the protective coating reduces the number per unit area of glass chips adhered to the glass surface by at least 90 percent compared to the number per unit area of glass chips adhered to an uncoated surface under comparable conditions.

39. A method in accordance with claim 38, wherein the number per unit area of glass chips adhered to the surface is reduced by at least 95 percent.

40. An article of manufacture comprising:
(a) a glass sheet having at least one substantially flat surface; and
(b) a protective coating on the substantially flat surface comprising at least one polymeric acid, said coating having a thickness of at least 0.01 microns;
wherein
(i) the protective coating protects the surface from ambient contaminants and contaminants produced during the processing of the glass and/or scratching; and
(ii) the protective coating can be removed through application of a cleaning composition to result in a substantially clean surface.

41. An article in accordance with claim 40, wherein the glass surface has a water contact angle of equal to or less than 8° after the protective coating is sufficiently removed by a cleaning composition.

42. An article in accordance with claim 41, wherein the glass surface has a mean square surface roughness less than or equal to 0.40 as measured by atomic force microscopy on a 20×20 μm area.

43. An article in accordance with claim 40, wherein the cleaning composition is a basic aqueous solution having pH of equal to or above 10, and the at least one polymeric acid has a solubility in neutral water of 0.5-50% by weight, and a solubility in the cleaning composition of at least 10% by weight.

44. An article in accordance with claim 43, wherein the at least one polymeric acid has a solubility in neutral water of 1-40% by weight, and a solubility in the cleaning composition of at least 30% by weight.

45. An article in accordance with claim 43, wherein the at least one polymeric acid has a solubility in neutral water of 2-30% by weight, and a solubility in the cleaning composition of at least 50% by weight.

46. An article in accordance with any one of claims 40 to 45, wherein the at least one polymeric acid is selected from the group consisting of (i) homopolymers and copolymers of carboxylic acid, phenols and acid anhydrides, salts and partial salts thereof, and (ii) mixtures and other combinations of the polymers.

47. An article in accordance with claim 46, wherein the at least one polymeric acid is selected from the group consisting of (i) homopolymers and copolymers of acrylic acid, methacrylic acid, maleic acid and their hydrides, salts and partial salts thereof, and (ii) mixtures and other combinations of the polymers.

48. An article in accordance with claim 40, wherein the protective coating has a thickness of less than 50 microns.

49. An article in accordance with claim 48, wherein the protective coating has a thickness of between 0.1 microns and 20 microns.

50. An article in accordance with claim 40, wherein the protective coating reduces the number per unit area of glass chips adhered to the surface by at least 90 percent compared to the number per unit area of glass chips adhered to an uncoated surface under comparable conditions.

51. An article in accordance with claim 50, wherein the number per unit area of glass chips adhered to the surface is reduced by at least 95 percent.

52. An article in accordance with claim 40, wherein the glass comprises at least two substantially flat surfaces, both surfaces have a coating comprising at least one polymeric acid, and each of the coatings has a thickness of at least 0.01 microns.

53. An article in accordance with claim 40, wherein the glass is suitable for producing the substrate of a liquid crystal display.
